(19) United States
(12) Patent Application Publication
(10) Pub. No.: US 2018/0134521 A1
(43) Pub. Date: May 17, 2018

(54) UNLOCKING KEY WITH AUTHORIZATION DEVICE

(71) Applicant: Otis Elevator Company, Farmington, CT (US)

(72) Inventors: Frederic Beauchaud, Coullons (FR); Franck Dominguez, Loiret (FR)

(21) Appl. No.: 15/574,170

(22) PCT Filed: Jun. 23, 2015
(86) PCT No.: PCT/IB2015/001561

§ 371 Date: Nov. 15, 2017

(51) Int. Cl. B66B 13/16; B66B 1/28; E05B 35/00; E05B 39/00

(52) U.S. Cl. CPC B66B 13/165; E05B 39/00; E05B 35/001; B66B 1/28

(57) ABSTRACT

An unlocking system including an elevator system with a lock having an unlocking mechanism and a keyway, the lock configured to secure a door of the elevator system and a detection device configured proximal to the keyway, the detection device configured to detect the presence of an authorization device configured to operate with the detection device that is located in proximity to the unlocking mechanism. If the detection device detects a key without an authorization device, the unlocking mechanism is configured to be disabled and may not be unlocked. If the detection device detects a key having an authorization device, the unlocking mechanism is enabled and the lock may be unlocked.

### BACKGROUND

The subject matter disclosed herein generally relates to systems for unlocking doors of elevator systems and, more particularly, to improved unlocking keys and systems for elevator doors.

Elevators may have maintenance performed on the elevator or components thereof from within an elevator shaft. Accordingly, access must be provided for a technician or other authorized person to gain access to the elevator shaft. Traditional access is provided at each landing of the elevator shaft. That is, operation of the landing doors is performed such that the landing doors may be opened when an elevator is not at the particular landing, so that the technician or other authorized person may gain access to the elevator shaft and perform a desired operation.

For safety reasons, the landing doors of an elevator are locked and cannot be opened when an elevator car is not present. In order to gain access to an installation within an elevator system, a technician may have a specific unlocking key, which allows the technician to open the landing doors of the elevator. These specific keys are becoming more common and potentially easy to obtain. The availability of these keys offers the possibility that unauthorized persons may attempt to gain access to an elevator shaft. Today these non-authorized accesses may not be detected and the access may risk the safety of the non-authorized persons.

The above safety concerns may apply to any doors within an elevator system, including top of car emergency exit doors or hatchways, opening the car operating panel, or other panels or doors associated with elevator systems. That is, most, if not all, doors within elevator systems must be locked for safety reasons. Preventing opening of any doors within an elevator system is a safety concern, and further detection of such access may not be possible in current systems.

### SUMMARY

According to one embodiment, an unlocking system is provided. The System includes an elevator system, a lock having an unlocking mechanism and a keyway, the lock configured to secure a door of the elevator system, and a detection device configured proximal to the keyway, the detection device configured to detect the presence of an authorization device configured to operate with the detection device that is located in proximity to the unlocking mechanism. If the detection device detects a key without an authorization device, the unlocking mechanism is configured to be disabled and may not be unlocked. If the detection device detects a key having an authorization device, the unlocking mechanism is enabled and the lock may be unlocked.

In addition to one or more of the features described above, or as an alternative, further embodiments may include a key having an authorization device disposed within the key and configured to at least one of communicate with the detection device and be detected by the detection device.

In addition to one or more of the features described above, or as an alternative, further embodiments may include an elevator controller configured to communicate with the detection device.

In addition to one or more of the features described above, or as an alternative, further embodiments may include that, if the detection device detects a key without an authorization device, the elevator controller is configured to stop an elevator car in an elevator shaft.

In addition to one or more of the features described above, or as an alternative, further embodiments may include that at least one of the detection device and the elevator controller are configured to send a notification to an authority when the detection device detects a key without an authorization device.

In addition to one or more of the features described above, or as an alternative, further embodiments may include a securing device, wherein if the detection device detects a key without an authorization device, the securing device is configured to secure the door in a locked position.

In addition to one or more of the features described above, or as an alternative, further embodiments may include that the door is a landing door of the elevator system and wherein the lock is configured to lock the landing door when an elevator car is not present at the landing door.

In addition to one or more of the features described above, or as an alternative, further embodiments may include that at least one of the lock and the detection device are located within a lintel of the landing door.

According to another embodiment, a method of operating an elevator is provided. The method includes detecting an unlocking access attempt of an unlocking mechanism of a door of an elevator system and determining if the unlocking access attempt is authorized. If the unlocking access attempt is authorized, permitting the unlocking access attempt, and if the unlocking access attempt is unauthorized, preventing the unlocking access attempt.

In addition to one or more of the features described above, or as an alternative, further embodiments may include, if the unlocking access attempt is unauthorized, sending a message to an authority.

In addition to one or more of the features described above, or as an alternative, further embodiments may include, if the unlocking access attempt is authorized, sending a message to an authority.

In addition to one or more of the features described above, or as an alternative, further embodiments may include, if the unlocking access attempt is unauthorized, securing the door to prevent opening of the door.

In addition to one or more of the features described above, or as an alternative, further embodiments may include, if the unlocking access attempt is unauthorized, stopping an elevator car in an elevator shaft.

In addition to one or more of the features described above, or as an alternative, further embodiments may include that the detecting is performed by a detection device located proximal to the unlocking mechanism.

In addition to one or more of the features described above, or as an alternative, further embodiments may include that the door is a landing door of the elevator system.

Technical effects of embodiments of the present disclosure include an elevator shaft access system configured to prevent access to opening of doors of elevator systems by unauthorized persons. Further technical effects include a key for an elevator system having an integrated authorization device. Further technical effects include an elevator system with an ability to identify an authorized access of a door of an elevator system. Further technical effects include an elevator shaft lock system configured to prevent access when an authorized access is attempted.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator unlocking key and an authorization device in accordance with an embodiment of the present disclosure;

FIG. 2 is a schematic illustration of an elevator landing door incorporating an embodiment described herein;

FIG. 3 is a schematic illustration of an elevator landing and enlarged view of locking mechanism in accordance with an embodiment described herein; and

FIG. 4 is a process in accordance with an embodiment of the present disclosure.

### DETAILED DESCRIPTION

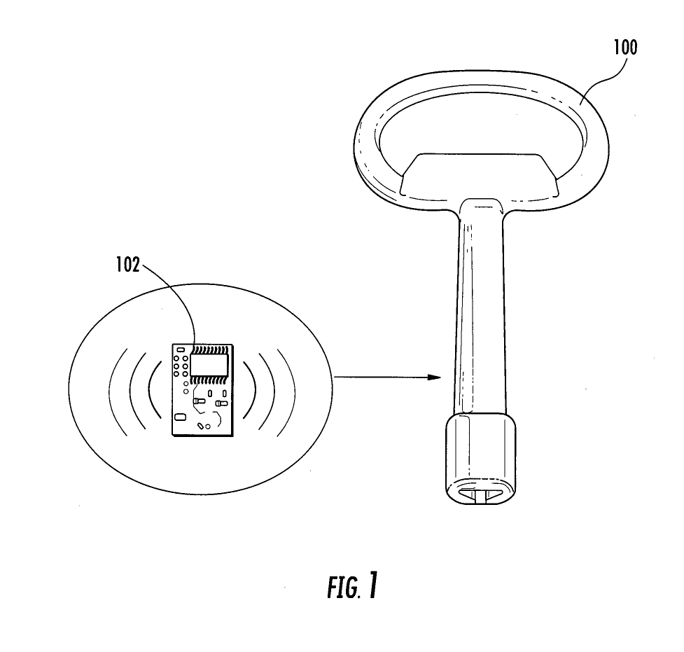

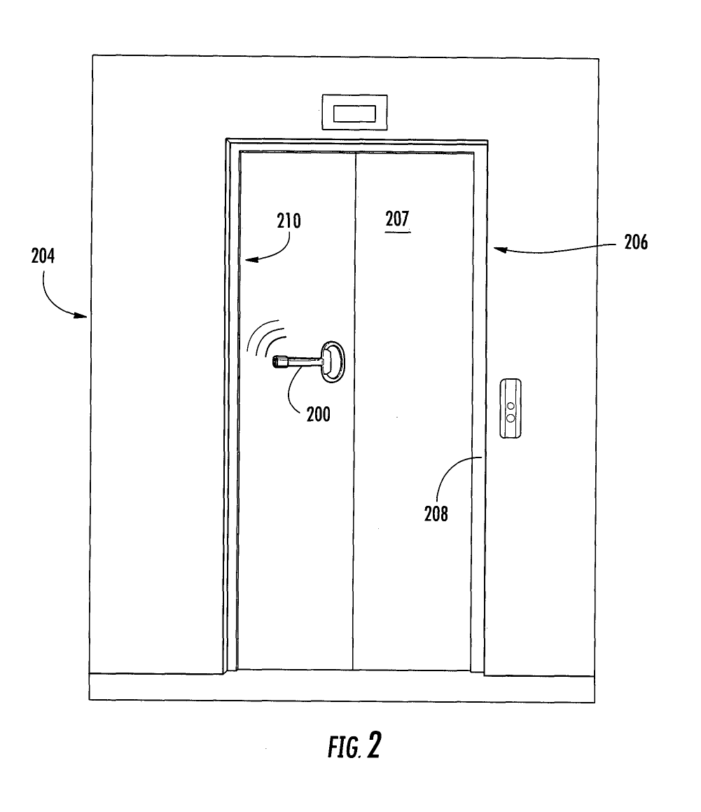

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. 1 may be labeled “1a” and a similar feature in FIG. 2 may be labeled “2a.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

During maintenance, inspection, and other operations performed on elevators and elevator systems, a technician may be required to open a door of the elevator system, including, but not limited to landing doors, top of car emergency exit doors or hatchways, car operating panels, or other panels or doors associated with elevator systems, to gain access to the elevator shaft. As shown and described herein, the disclosure will be with reference to landing doors, although those of skill in the art will appreciate that the embodiments described herein, and variations thereof, may be applied to any door or opening within an elevator system.

Landing doors are configured to be in a locked state at all times, and open only when an elevator car is located at the particular landing door. That is, when an elevator car is not located at a particular landing door, the landing door is locked and an opening operation of the landing door is prevented by a locking mechanism. To operate the locking mechanism, a key may be inserted into a keyway of the locking mechanism, which may be installed in a portion of the landing door frame, to disable the locking mechanism. With the locking mechanism disabled, the landing door may be opened even when an elevator car is not present at the landing door.

Traditionally, the unlocking keys used by technicians to unlock the locking mechanisms of landing doors are specific unlocking keys configured and designed for the purpose. However, although access to the unlocking keys is restricted, the ability of an unauthorized person to obtain an unlocking key poses a risk to safety.

Embodiments disclosed herein provide a modified locking mechanism and a modified unlocking key that adds additional security to prevent unauthorized access to the elevator shaft. In accordance with some embodiments, an authorization device is integrated into an unlocking key and is configured to be identified by an elevator system to determine that the unlocking key is an authorized key. An authorization device, as used herein, is any type of authorization device that may be configured with a system for authentication and/or identification, and includes, but is not limited to, a contactless smart card, an RFID card, a wireless card, and other types of cards, chips, circuit boards, and systems that may be synchronized with an unlocking mechanism, as described herein. It will be appreciated that the authorization device described herein is synchronized or associated with the other operating and functional systems and devices disclosed herein.

Various example embodiments are provided herein. Although specific embodiments are described, those of skill in the art will appreciate that other embodiments and configurations are possible without departing from the scope of the present disclosure.

Turning to FIG. 1, a schematic illustration of an elevator landing door unlocking key 100 with a schematic of a authorization device 102 is shown. In accordance with embodiments disclosed herein, the authorization device 102 may be installed into or integrated with the unlocking key 100. The authorization device 102 is an electronic chip or circuit board configured to enable contactless communication. For example, the authorization device 102 may be an active RFID chip or other type of wireless communicator.

The authorization device 102 is configured to communicate with a portion of an elevator system when in proximity to a keyway that is used to unlock a landing door locking mechanism. When the unlocking key 100, with the authorization device 102 integrated therewith, is presented near or into the keyway, the elevator system is configured to detect the presence of the authorization device 102 and allow an unlocking of the landing door locking mechanism. The elevator system may include one or more sensors or other electronics that are configured to detect the presence of an authorization device, and further may include electronics or other components that are configured to perform communications and/or take actions in response to the detection or a key that does or does not include an authorization device.

In some embodiments, the authorization device 102 may be electronically synchronized to or configured with a specific elevator system, i.e., the authorization device 102 may be an authorized device that is configured to operate with the elevator system. The elevator system may include a controller or other electrical control mechanism, as known in the art. It will be appreciated that such elevator controllers are well known, and thus are not described in detail or shown herein. The authorization device 102 may communicate with the elevator controller directly or indirectly, and may be by wireless means. Alternatively, the authorization device 102 may communicate with a detection device, such as one or more sensors, that is located at the particular landing door to which the unlocking key 100 is presented. In such an embodiment, the detection device may then send a communication, over wire or wirelessly or a combination thereof, to an elevator controller or other control system.

When the communication reaches the elevator controller, the elevator controller recognizes the unlocking key 100 and the authorization device 102 therein, as an authorized unlocking key. The elevator controller may then take no action and permit the user to unlock the landing door locking mechanism and open the landing door. In some embodiments, the elevator controller may be configured to send a notice to a security system or to security personnel or other persons, indicating that an authorized access is being attempted. This may be advantageous for other persons to keep track of which landing doors are being opened and knowing where technicians or other authorized personnel are located.

However, if an unauthorized unlocking key is attempted to be used to open a landing door, the system described herein may prevent the unauthorized user from unlocking the landing door locking mechanism and/or opening the landing door. An unauthorized unlocking key may be a key without an authorization device, such as a key without an authorized, synchronized, or programmed contactless smartcard or other authentication or authorization device or component. For example, in some embodiments, when an improper or unauthorized key is presented, the elevator car within the elevator shaft may be stopped. The stopping of the elevator car may be executed for safety reasons so that an unauthorized person is not in danger from a moving elevator car within the elevator shaft, if the landing doors are successfully opened. Further, in some embodiments, because an unlocking attempt is made with a key without the authorization device, the system may immediately detect the unauthorized access attempt. The system may then send an alert message to a security service, janitor, or other monitoring or other appropriate service or person to notify them of the unauthorized attempt.

Turning to FIG. 2, a schematic illustration of a landing door employing an embodiment of the present disclosure is shown. As shown, a landing 204 includes a landing door 206 having panels 207 and a frame 208. Located in the side of the frame 208 may be a keyway 210. The keyway 210 may be part of a locking mechanism of the landing door lock. The keyway 210 may be configured with an electrical component or sensors configured to detect attempted access to the keyway 210. That is, when a key, such as unlocking key 200, is attempted to be inserted into the keyway 210, the keyway 210 or associated components are configured to detect if the key is authorized or not. If the key is not authorized, an unlocking operation may be prevented and the elevator car in the elevator shaft may be stopped. However, if the key is an unlocking key 200 with an integrated or internal authorization device, the keyway 210 or associated components may allow for the landing door locking mechanism to be unlocked and/or disabled, and thus the landing door 206 may be opened.

In an alternative embodiment, when an unauthorized unlocking key is introduced into a keyway of a landing door, a securing device (e.g., a hook or axle) may move or actuate in order to lock the elevator landing door closed. The securing device may prohibit total access to the elevator shaft. Similar to the above described embodiment, an alert message may be sent to a security service, janitor, or other monitoring or other appropriate service or person.

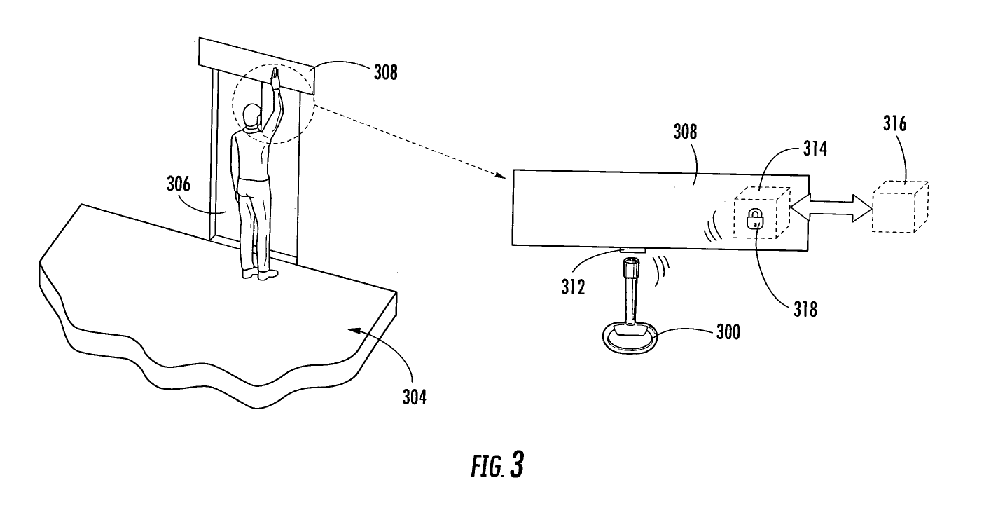

Turning now to FIG. 3, a schematic illustration of a landing and an enlarged elevator unlocking mechanism are shown. The elevator landing 304 includes a landing door 306 having panels and a frame 308. A user, as shown, may access a landing door unlocking mechanism (shown in more detail on right side of page) located in a portion of the frame 308, such as the lintel. A user may insert an unlocking key 300 into a keyway 312. A detection device 314 is configured to detect if the unlocking key 300 includes an authorization device or not.

In this embodiment, if the detection device 314 detects an authorization device within the unlocking key 300, a message is sent to an elevator controller 316, as described above. That is, the detection device 314 may, in some embodiments, authenticate or detect an authorization device in a key inserted into an unlocking mechanism. In some embodiments, the controller 316 may be the elevator controller. In other embodiments, the controller 316 may be a dedicated controller configured for the locking/unlocking purpose and/or for security purposes. In some embodiments the controller 316 may store information related to the access attempt, such as logging key identifier information, time of access, landing floor, etc. In other embodiments, this information may be transmitted to a remote data logger. In either event, in some embodiments, the system may be configured to log information about the access of the unlocking mechanism. Thus, in some embodiments, if an authorized key is presented, the elevator landing doors may be opened, and information may be logged. In some embodiments, the information logging or data collection may be omitted or merely optional.

If the unlocking key is determined to be unauthorized by the detection device 314, i.e., no authorization device present or detected, the detection device 314 may send an appropriate message to the controller 316. When an unauthorized access attempt message is received by the controller 316, the controller 316 may stop an elevator car located in an elevator shaft and controlled by the controller 316. Further, the controller 316 may be configured to send a message or alert to a security service, janitor, or other monitoring system or person. In some embodiments, an alarm may be triggered, such as a light, a buzzer, or other type of alarm or notification located at the landing door when an unauthorized access attempt is determined.

The improper access attempt may be logged, similar to that described above. Further, when an improper access attempt is detected, the elevator may be disabled until an authorized person or system verifies the system is ready to be re-enabled.

In some embodiments, as shown in FIG. 3, when an unauthorized access attempt is detected by the detection device 314, the detection device 314 may activate a securing device 318 that is part of the unlocking mechanism of the landing door. The securing device 318 may be configured to provide additional locking measures to the landing door in the event of an unauthorized access attempt. The securing device 318 may be an electronic and/or mechanical system configured to securely lock the elevator landing doors.

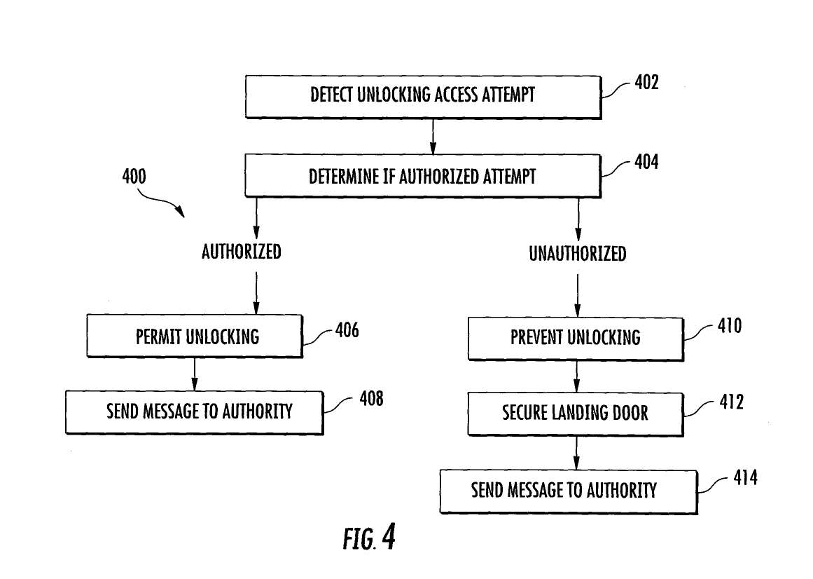

Turning now to FIG. 4, a process in accordance with the present disclosure is shown. Process 400 may be performed with systems and unlocking keys as described above or with other systems and configurations, without departing from the scope of the disclosure.

At step 402, a detection mechanism is configured to detect an attempt to disable or unlock a landing door lock when an elevator car is not present at the landing door. Such detection may be based on an insertion of a key into a keyway and a sensor monitoring for the presence or absence of an authorization device within the key. In some embodiments the detection mechanism is configured as one or more sensors configured to detect an authorization device. In some embodiments, the detection mechanism and an authorization device may be paired or synchronized such that the detection mechanism is configured to detect and authorize only the paired or synchronized authorization device.

At step 404, based on the detection of step 402, a determination is made whether the attempt to unlock the landing door lock is authorized or not. If an authorization device is detected within the key at step 404 it is determined that the unlocking attempt is authorized, and the process continues to step 406. In some embodiments, the authorization may be granted to only synchronized, paired, or otherwise identified (e.g., specific identification numbers, serial numbers, wireless pulses, etc.) authorization devices.

However, if at step 404 it is determined that the unlocking attempt is not authorized, then the process may proceed to step 410. For example, if at step 404 it is determined that a key is inserted into a keyway and an authorization device is not detected, or a non-synchronized or non-authorized key with a device is detected, the attempt may be determined to be unauthorized.

At step 404, if the attempt is determined to be authorized, at step 406 the unlocking process is permitted. That is, the key may be operated within the keyway to disable or open a landing door locking mechanism, and thus a person may successfully open the landing door, even if an elevator car is not present.

Further, at step 408, the system may send a message to an appropriate monitoring service or person to provide a notification of the authorized access. It will be appreciated that steps 406 and 408 may be performed simultaneously. Moreover, step 408 may be optional or omitted in some embodiments. The notification may be sent by the detection mechanism at the landing door or may be relayed or sent from a controller of the elevator system.

Referring back to step 404, if it is determined that the attempt is unauthorized the process may proceed to step 410 wherein the system prevents an unlocking of the landing door locking mechanism. That is, a key that is inserted into a keyway may not unlock or disable the landing door locking mechanism. Thus, the elevator landing door may not be opened and unlocking is prevented.

Further, in some embodiments, at step 412, the landing door may be secured. That is, if an unauthorized attempt is made, a hook, axle, or other device may move or actuate in order to lock the elevator landing door closed. This may be an additional securing device in order to prevent any unauthorized access to open an elevator landing door.

Finally, at step 414, a message may be sent to an appropriate authority, such as to security personnel, a security system, a janitor, or other person or system. As will be appreciated by those of skill in the art, in some embodiments, steps 410-414 may be performed simultaneously or in any desired order. Further, in some embodiments various aspects of steps 410-414 may be optional or omitted.

For example, in some embodiments, steps 412 and 414 may be omitted. In such embodiments, when an unauthorized attempt to unlock a landing door is detected, the system may lock or secure the landing door such that it cannot be opened.

In another embodiment, for example, steps 410 and 412 may be omitted. In such an embodiment, when an unauthorized unlocking attempt is detected, a notification may be sent to an authority providing notification of unauthorized access to an elevator shaft. In some such embodiments, the landing door may be able to be opened. In further embodiments, when the landing door is opened by an unauthorized attempt, an elevator car may be stopped within the elevator shaft.

The prevention mechanism of embodiments described herein may be electronic and/or mechanical. For example, in some embodiments, the landing door locking mechanism may be constantly in a state of disabled, i.e., the locking mechanism cannot be unlocked. Then, when an authorized key is presented into the keyway, the locking mechanism may engage and function to unlock the landing door locking mechanism. In other embodiments, a stop or other mechanical feature may be located within the keyway such that the key may not be completely inserted into the keyway without an authorization device being detected. In other embodiments, when an unauthorized key is inserted into the keyway, the locking mechanism may make an active preventative response, such as disengaging, disabling or otherwise preventing an unlocking of the locking mechanism.

Advantageously, embodiments described herein provide a security locking mechanism that is configured to permit only authorized access to an elevator shaft through a landing door. Such system is configured and operates in conjunction with the disabling mechanism for a landing door locking mechanism. Advantageously, safety may be provided for a person accessing the elevator shaft, and further safety may be provided to unauthorized persons, by preventing access to the elevator shaft. Moreover, advantageously, security may be provided for materials and components within an elevator shaft as only authorized access may be permitted.

Furthermore, in accordance with some embodiments, the modified unlocking keys may include authorization devices installed therein may be compatible with old door locks that do not incorporate the security mechanism. That is, traditional style landing door lock unlocking keys may be installed with the authorization device, and further, the modified keys may be compatible with systems that do not incorporate the features disclosed herein. The authorization devices disclosed herein may also be integrated into the devices, such as keys or other devices, which are used to open the COP and/or the top of car emergency exit.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

For example, although described with respect to landing door locking mechanisms, those of skill in the art will appreciate the key systems described herein may be used in other elevator applications, such as top of car emergency exit doors or hatchways, opening the car operating panel, or other panels or doors associated with elevator systems.

Accordingly, the present disclosure is not to be seen as limited by the foregoing description, but is only limited by the scope of the appended claims.

1. An unlocking system comprising:
an elevator system;
a lock having an unlocking mechanism and a keyway, the lock configured to secure a door of the elevator system; and
a detection device configured proximal to the keyway, the detection device configured to detect the presence of an authorization device configured to operate with the detection device that is located in proximity to the unlocking mechanism;
wherein, if the detection device detects a key without an authorization device, the unlocking mechanism is configured to be disabled and may not be unlocked, and
wherein, if the detection device detects a key having an authorization device, the unlocking mechanism is enabled and the lock may be unlocked.

2. The system of claim 1, further comprising a key having an authorization device disposed within the key and configured to at least one of communicate with the detection device and be detected by the detection device.

3. The system of claim 1, further comprising an elevator controller configured to communicate with the detection device.

4. The system of claim 3, wherein, if the detection device detects a key without an authorization device, the elevator controller is configured to stop an elevator car in an elevator shaft.

5. The system of claim 3, wherein at least one of the detection device and the elevator controller are configured to send a notification to an authority when the detection device detects a key without an authorization device.

6. The system of claim 1, further comprising a securing device, wherein if the detection device detects a key without an authorization device, the securing device is configured to secure the door in a locked position.

7. The system of claim 1, wherein the door is a landing door of the elevator system and wherein the lock is configured to lock the landing door when an elevator car is not present at the landing door.

8. The system of claim 7, wherein at least one of the lock and the detection device are located within a lintel of the landing door.

9. A method of operating an elevator, the method comprising:
detecting an unlocking access attempt of an unlocking mechanism of a door of an elevator system; and
determining if the unlocking access attempt is authorized;
if the unlocking access attempt is authorized, permitting the unlocking access attempt;
if the unlocking access attempt is unauthorized, preventing the unlocking access attempt.

10. The method of claim 9, further comprising, if the unlocking access attempt is unauthorized, sending a message to an authority.

11. The method of claim 9, further comprising, if the unlocking access attempt is authorized, sending a message to an authority.

12. The method of claim 9, further comprising, if the unlocking access attempt is unauthorized, securing the door to prevent opening of the door.

13. The method of claim 9, further comprising, if the unlocking access attempt is unauthorized, stopping an elevator car in an elevator shaft.

14. The method of claim 9, wherein the detecting is performed by a detection device located proximal to the unlocking mechanism.

15. The method of claim 9, wherein the door is a landing door of the elevator system.
